(19) United States
(12) Patent Application Publication
(10) Pub. No.: US 2006/0169244 A1
(43) Pub. Date: Aug. 3, 2006

(54) Fluid injector

(76) Inventor: Jeffrey Allen, Norfolk (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/549,521

(22) PCT Filed: Feb. 6, 2004
(86) PCT No.: PCT/GB04/00465

§ 371 Date: Sep. 19, 2005

(30) Foreign Application Priority Data
Mar. 22, 2003 (GB) 0306658.6

(51) Int. Cl. F02D 43/00; F02M 57/06

(52) U.S. Cl. 123/297; 123/406.43

(57) ABSTRACT

A fluid injector (2) with a channel (4) terminating in one or more orifices (7) and being, in use, operatively connected to a fluid supply means so that fluid may be supplied to the injector in order to pass through said channel (4) to exit by one or more of said orifices into a medium; wherein the injector comprises a sensor (12) in contact with the medium into which fluid is injected; and processing means operating in conjunction with the sensor to derive condition values and orchestrate appropriate control of the operation of the injector and/or any other relevant device

### FIELD OF THE INVENTION

The invention relates to fluid injectors with a channel terminating in one or more orifices which are, in use, operatively connected to a fluid supply means so that fluid may be supplied to the injector in order to pass through its channel to exit by one or more orifices into a medium. The inventive system may be employed in any injection application; it is however particularly well suited for applications in internal combustion engines.

The invention also relates to engine management systems designed to control injection and ignition within an engine's combustion chamber.

### BACKGROUND TO THE INVENTION AND PRIOR ART KNOWN TO THE APPLICANT(S)

Combustion engines are nowadays typically equipped with electronically controlled fuel injectors for delivering the fuel directly into the engine cylinder. Injectors may take a wide variety of forms appropriately selected for a given engine application. These may include for example electrostatic, pressure swirl or air-assisted atomisation injectors. Generally, direct injection internal combustion engines are progressively replacing manifold carburettor fuel systems since these can more readily be controlled to achieve improved emission characteristics in order to meet the increasingly stringent legislations governing emissions.

In order to avoid having to interfere with the current well refined sparkplugs, the upgrade to direct injection has primarily taken the form of introducing a separate injector. In this manner, engine manufacturers have been able to continue generally unaltered the production and sale of sparkplug units whilst at the same time producing specific fuel injector units to operate alongside separate sparkplug units in combustion chambers.

Combining spark plug units and injector units into a single unit has not been generally envisaged. One of the reasons for not envisaging such a combination is that of unnecessary complexity without any foreseeable benefits. A hypothetical combined sparkplug and injector unit has been traditionally viewed as oversized, requiring very intense research and development to achieve the necessary strict tolerances and reduce the unit's size to within an acceptable limit. The additional cost of producing a combined unit is thought by the skilled man in the art not to yield any practical benefit.

The wealth of patents covering improvements to spark plug units alone and those covering injection units alone versus any patent applications covering single combined spark plug and injector units clearly shows that the conventional thinking in the field of internal combustion engines continues to view spark plugs and injectors as necessarily separate units.

Combined spark plug and atomiser units are seldom proposed. One recent example is disclosed in International Patent Application No PCT/GB01/04646 where electrostatic atomisation is provided alongside the generation of a sufficient difference in potential to cause ignition of the atomised fuel. Another combined system is disclosed in the French Patent FR 900.408 published in 1945 which deals with an overly complex atomiser and sparkplug system. Only the presence of the necessary electrical connector for atomisation in these systems seems to justify the spark-electrode presence in the injector.

In an effort to meet increasingly stringent emission legislations introduced across the world, the automotive industry has produced sophisticated fuel injection systems governed by engine management systems. FIG. 1 shows an example of an engine management system generally referenced 1. The engine management system revolves around an engine control unit (commonly referred to as an ECU in the field) equipped with processing means. Conventionally, an engine management system operates in conjunction with a crankshaft position sensor, a camshaft position sensor, a throttle position sensor, a coolant temperature sensor, an air mass flow sensor, a knock sensor and an oxygen sensor which feed information to the ECU which are then often only interpreted to monitor a single aspect of the engine's condition in order to optimise fuel injection and ignition pulse. The cost of such a multi-part engine management system is usually readily absorbed and therefore justified when fitted to large capacity multi-cylinder engines.

For smaller engines where the market value of the equipment is relatively small, the expense of such conventional engine management systems is not feasible. Consequently, smaller engines of the type employed commonly in motorcycles, leisure crafts or even powered hand tools run without any such complex but otherwise beneficial engine management systems.

However, legislations are beginning to apply not only to automotive transport in the West but to transport throughout the world and progressively in the future to all types of smaller engines which are currently deprived of these engine management systems primarily on economic grounds.

One of the objectives of the invention is to provide an economically viable engine management system which may be employed in all engine types but may be particularly well suited to control the operation and ultimately the emissions of so-called small engines which may for example have only one cylinder.

Another objective of the invention is to simplify the engine control system without requiring or with only minimum modification to existing engine configurations.

Another objective is to provide an engine management system with a more rapid and even an in-cycle control of fuel injection and ignition pulse.

A more general objective of the invention is to present improvements to fluid injectors of any kind.

### SUMMARY OF THE INVENTION

In a first broad independent aspect, the invention presents a fluid injector with a channel terminating in one or more orifices and being, in use, operatively connected to a fluid supply means so that fluid may be supplied to the injector in order to pass through said channel to exit by one or more of said orifices into a medium; wherein the injector comprises a sensor in contact with the medium into which fluid is injected; and processing means operating in conjunction with the sensor to derive condition values and orchestrate appropriate control of the operation of the injector and/or any other relevant device.

This configuration marks a complete departure from conventional thinking by considering the combination of an injector and a sensor. This combination allows more precise control of the injection and therefore economy of injected fluid particularly in a changing medium condition such as that present in a combustion chamber. This configuration may also do away with more complex sensing arrangements and constitute an altogether more practical and cost-effective injection system.

Advantageously, the injector may be combined with spark-electrodes so as to form a combined spark plug and injector unit, and in use, the medium may be constituted by the contents of a combustion chamber. By doing away with the well-established requirements for a separate spark plug unit and injector unit, this combination yields unforeseen advantages which are for example more precise control of fuel injection and ignition pulse.

Advantageously, part of the sensor may be an ion sensing electrode for sensing electrical resistance across the gap between the ion sensing electrode and a low potential electrode.

This configuration is particularly advantageous because it is relatively simple and generally more compact than configurations equipped with optical or piezoelectric sensors. There may be no need in this configuration for separate electrical connectors for ignition and sensing.

The invention also covers an engine management system incorporating one or more fluid injectors in accordance with any of the preceding aspects.

This configuration is particularly advantageous because it does away with the complex conventional engine management system's requirements of typically incorporating crankshaft position sensors, camshaft position sensors, throttle position sensors, coolant temperature sensors, air mass flow sensors, knock sensors and oxygen sensors. The elimination of any or all of these sensors, whilst at least obtaining data of equivalent use will amount to considerable cost savings and allow such an engine management system to be employed in so-called small engines which hitherto would not incorporate an engine management system for cost reasons but are now susceptible of having the same benefits particularly in terms of fuel economy and emission reductions as larger engines equipped with relatively expensive engine management systems.

In a second broad independent aspect, the invention covers an engine management system, comprising an engine control unit (ECU) operatively connected to one or more sensors, wherein at least one of said sensors is combined with a fluid injector and is in contact with the medium into which fluid is injected so as to derive condition values and orchestrate appropriate engine control.

This configuration achieves a sophisticated system without requiring an excessive number of sensors. Combining a sensor with a fluid injector and arranging the sensor to be in contact with the medium, marls a complete departure from conventional thinking which considers that engine operation sensors should be located in a variety of locations of the engine other than in contact with the medium where fluid is injected. One of the advantages of this configuration is a more direct derivation of condition values allowing a more rapid control of the engine.

In a subsidiary aspect in accordance with the second broad independent aspect the engine management system operates in conjunction with a single sensor.

In this configuration, there is no need for complex interpretation from various sensor sources. This configuration also allows the cycle analysis to occur in-cycle which would reduce required control time and improve the control quality. Furthermore, an engine management system of this kind will be particularly cost-effective which will open doors to applications which were hitherto not explored on economical grounds. Such advancement in the art also has considerable foreseeable environmental benefits.

In a further subsidiary aspect, the system comprises no crankshaft sensor. This configuration represents a radical department from the well established thought in the field that all engine management systems require at least a crankshaft sensor.

### THE DESCRIPTION OF THE FIGURES

FIG. 1 shows an engine management system of known kind in the form of a flow chart.

FIG. 2 presents a cross-sectional view of a fluid injector in accordance with a first embodiment of the invention.

FIG. 3 shows a cross-sectional view of a fluid injector in accordance with a second embodiment of the invention.

FIG. 4 shows a cross-sectional view of a fluid injector in accordance with a third embodiment of the invention.

FIG. 5 shows a cross-sectional view of a fluid injector in accordance with a fourth embodiment of the invention.

FIG. 6 shows a flow chart for an engine management system in accordance with the invention.

### DETAILED DESCRIPTION OF THE FIGURES

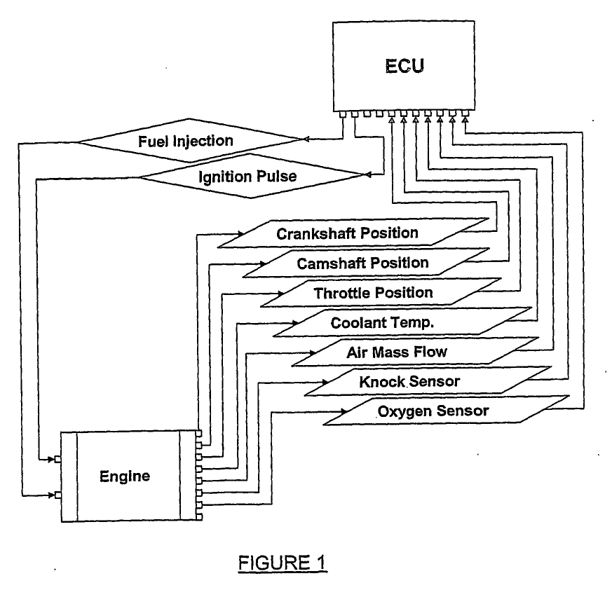

FIG. 1 was described in detail in the section entitled Background to the Invention and Prior Art known to the Applicant(s).

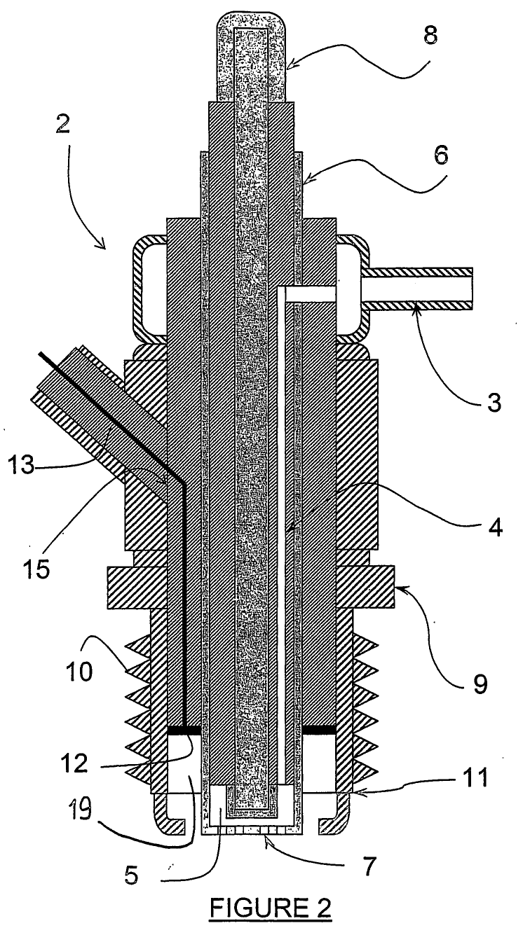

FIG. 2 shows a fluid injector generally referenced 2 comprising a fluid inlet 3 for receiving fluid such as a fuel from a fluid supply unit (not illustrated in the drawing). The fluid supply unit may be of known kind and selected by the person skilled in the art from known alternatives. During injection, the pressurised fluid flows longitudinally through a passage 4 to exit into an electrostatic atomisation chamber 5. The walls of chamber 5 are partially constituted by an electrode with a number of orifices such as that referenced 7 to allow the fluid to exit from atomisation chamber 5 into a medium. The lower portion of housing 9 has a threaded surface 10 to permit the releasable engagement of the fluid injector to a cylinder of an internal combustion engine. When the fluid injector is appropriately mounted to the cylinder, the fluid exits into the medium contained therein.

Electrostatic atomisation in chamber 5 is achieved by applying an appropriate difference in potential between a central electrode 8 and electrode 6.

The lower portion of housing 9 is equipped with a ground electrode 11 sufficiently spaced from electrode 6 so that when an appropriate potential is applied between electrode 6 and electrode 11 an ignition spark may be produced.

As part of this fluid injector, there is provided a sensor generally referenced 15. One part of the sensor is formed as an annulus 12 located in contact with the medium. The annulus is set in a recess 19 formed within the lower portion of housing 9. The exposed portion of sensor 15 need not be of this geometry and could in order to reduce its area of exposure be limited to an eccentrically located disk. Annulus 12 may be designed to sense pressure and in so doing take the form of a piezoelectric crystal capable of generating a voltage representative of the pressure applied onto its surface by the medium. An annulus of this form may also be protected by a shield so as to avoid direct contact by the medium onto the sensitive piezoelectric crystal part of the sensor. Such a sensor shield may be made out of stainless steel or any other highly temperature resistant material as appropriate.

The electrical current generated by the piezoelectric crystal is then fed by a connector 13 to appropriate processing means (not illustrated in the figure).

The person skilled in the art will select an appropriate processing means with sufficient processing speed to deliver real time data on in-cylinder conditions and/or store and analyse historical data to establish any of the following:
1) Piston position necessary for determining crankshaft and camshaft position; in other words, the in-cylinder sensor allows the crankshaft position to be derived without requiring the traditional crankshaft adjacent position sensor,
2) Rate of pressure rise which may allow the determination of trapped air volume in the cylinder eliminating the need for a throttle sensor and air flow meter,
3) Combustion pressure directly to eliminate the need for a separate knock sensor,
4) Continuous combustion monitoring to establish a real time operation history of the engine to eliminate the need for a coolant sensor.

The processing means may be adapted to continually optimise the combustion cycle by constantly or periodically comparing current cycle data with previous cycles and reference cycles in real time to achieve closed loop control of the combustion events.

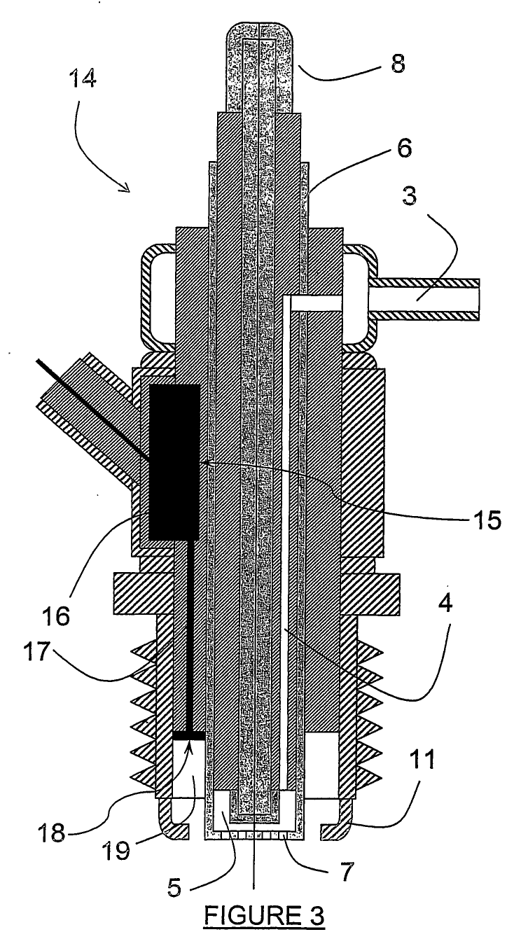

FIG. 3 presents a fluid injector 14 of the general kind described in detail with reference to FIG. 2 and therefore for clarity identical components have been allocated identical numerical references. Injector 14 incorporates an optical combustion sensor 15 located within body 9. Optical sensor 15 is composed of an optical generator & receiver 16 for producing an optical signal propagated down an optical guide 17 onto a deformable reflector 18 located in recess 19 to be in contact with the medium into which fluid is injected. As pressure varies in the medium reflector 18 deforms and reflects the light in a modified manner towards the light generator & receiver 16 which is operatively connected to processing means (not illustrated in the drawing) in order to control the operation of the injector or any other device as appropriate.

Optical combustion sensor 15 may also take the form of a spectroscopy system in which the deformable reflector would be replaced by for example a quartz window. This system would be designed to generate information on the proportions of combustion species present in the medium which would ultimately allow air-fuel ratios and emission information to be optimised as it is fed from cycle to cycle to the processing means. This system may also eliminate the need for separate exhaust oxygen sensors.

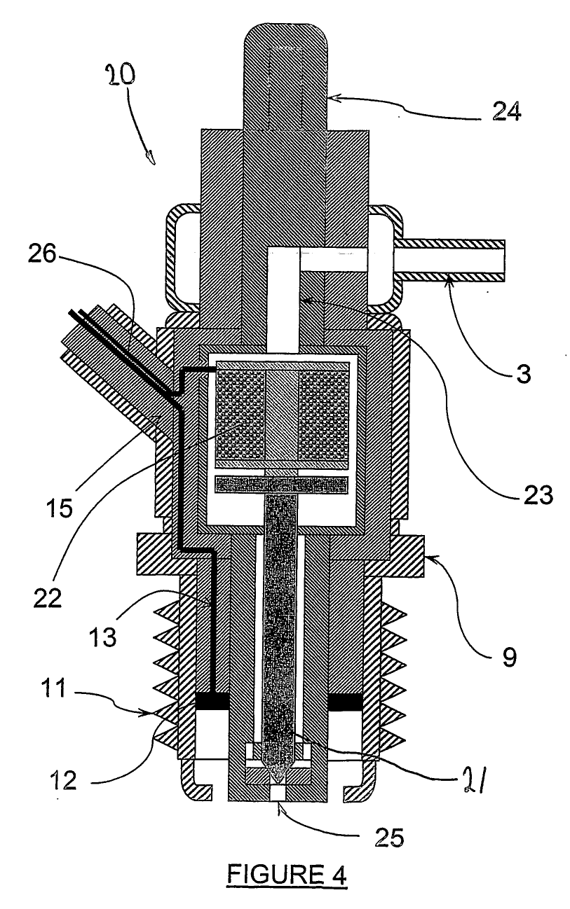

FIG. 4 shows a further fluid injector referenced 20 where similar components to those described with reference to FIG. 2 are given identical reference numbers. Injector 20 is a modification of the otherwise well known pressure swirl atomiser and therefore incorporates a plunger 21, a solenoid 22, a fuel passage 23, a central electrode 24 whose interaction with plunger 21 creates a so-called swirl effect discharge through orifice 25. The channel formed within housing 9 to accommodate the solenoid electrical connector 26 is also adapted to accommodate connector 13 of the pressure sensor 15. Similar sensor configurations to those proposed with reference to FIG. 2 are also envisaged in the context of this system.

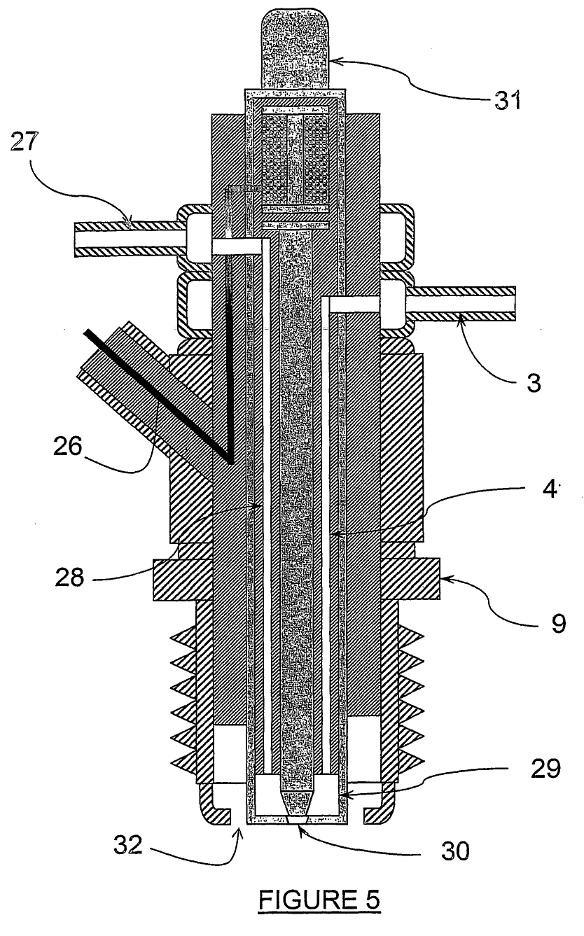

FIG. 5 presents an air assisted injector of known kind modified in accordance with the invention. In addition to fuel inlet 3 and fuel passage 4, there is provided an air inlet 27 leading to an air passage 28. The air is supplied as in standard injectors of this type in pressurised form. Both passages 4 and 28 run into a fluid mixing chamber 29. An orifice 30 is provided in a wall of the mixing chamber 29 to allow fuel discharge into the medium. An ignition and ion sensing electrode is provided centrally, a lower portion of which forms the mixing chamber 29. When electrode 31 is not firing it is adapted to measure resistance across gap 32. The ion sensing electrode may be adapted to measure electrical resistance within the chamber (when the low electrode is at least in part the chamber's wall). The ignition and ion sensing electrode is operatively connected to processing means (not illustrated in the figure) which determine the value of resistance across gap 32 and is adapted to derive condition values such as pressure, air fuel ratio and burning occurrence. This system is particularly advantageous because it occupies no more space than that required by the spark plug and injector members alone.

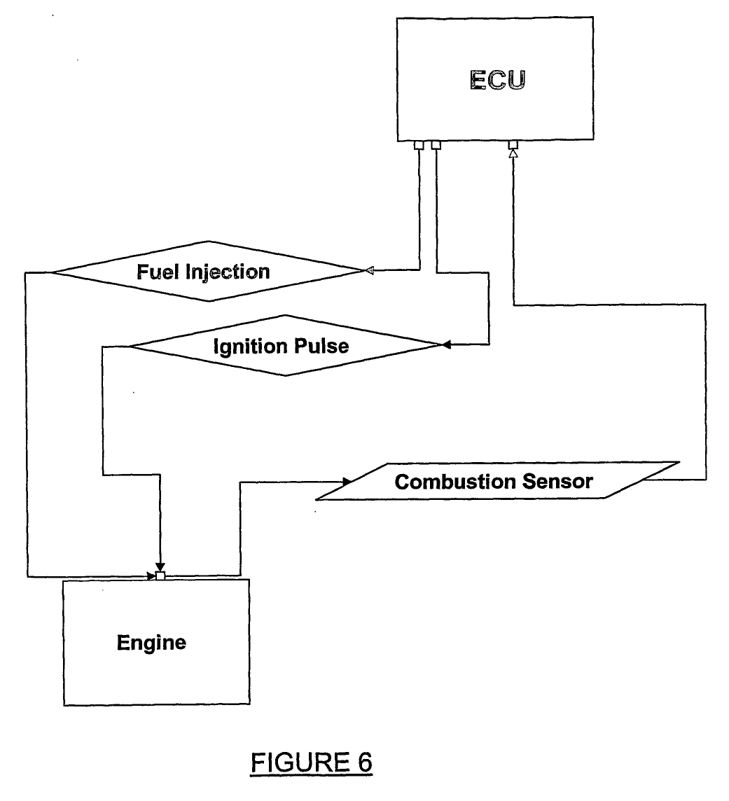

A comparison of the engine management system of FIG. 6 with the prior art system of FIG. 1 shows the radical simplification achieved by employing injectors of the kind described with reference to the previous figures.

The engine management system of FIG. 6 requires only a single sensor in order to achieve sophisticated control of the fuel injection and ignition pulse.

The illustrative embodiments discussed above have focused on improved injectors for operation in internal combustion engines. The invention is however not limited to these specific systems and may apply to a range of other injectors which have not been specifically described herein such as household sprays, drug injectors, cosmetic fluid sprays, synthesized solutions sprays or the like, all being within the scope of the Claims as appropriate which follow.

1-9. (canceled)

10. An engine management system operating in conjunction with a sensor located in contact with the medium of a combustion chamber of an internal combustion engine and processing means for controlling the spark and injection process of said engine; wherein said engine management system operates with a single sensor; whereby the engine management system uses only the input from one sensor; and said sensor monitors in-cycle combustion conditions by comparing current cycle data with reference cycles; whereby closed loop control of the combustion events occurs throughout the combustion cycles.

11. An engine management system according to claim 10, wherein the sensor is located in contact with the medium of a single combustion chamber engine.

12. An engine management system according to claim 10, wherein said single sensor is part of a combined spark and injector plug.

13. An engine management system according to claim 10, wherein the sensor delivers data to the processing means to determine at least the crankshaft position of said engine.

14. An engine management system according to claim 10, wherein the processing means analyses the data delivered to establish the rate of pressure rise to determine trapped air volume in cylinder.

15. An engine management system according to claim 10, wherein the processing means analyses the data delivered to establish the operation history of the engine.

16. An engine management system according to claim 10, wherein the sensor incorporates a deformable member in close proximity to the medium.

17. An engine management system according to claim 12, wherein the sensor is located radially outwards from the plug's central axis.
